(19) United States
(12) Patent Application Publication
(10) Pub. No.: US 2020/0346577 A1
(43) Pub. Date: Nov. 5, 2020

(54) Optical Device for a Motor Vehicle Providing Two Separate Lighting Functions

(71) Applicant: MARELLI AUTOMOTIVE LIGHTING FRANCE, Saint-Julien-du-Sault (FR)

(72) Inventors: Stéphanie Bergerat, Trappes (FR); Franck Arrivet, Trappes (FR)

(73) Assignee: MARELLI AUTOMOTIVE LIGHTING FRANCE, Saint-Julien-du-Sault (FR)

(21) Appl. No.: 16/644,247

(22) PCT Filed: Sep. 6, 2018
(86) PCT No.: PCT/FR2018/052178

§ 371 Date: Mar. 4, 2020

(30) Foreign Application Priority Data
Sep. 7, 2017 (FR) 1758265

(51) Int. Cl. B60Q 1/00; B60Q 1/26; F21S 41/32; F21S 41/148; F21S 43/14; F21S 43/31; F21S 41/36

(52) U.S. Cl. CPC B60Q 1/0058; B60Q 1/2607; F21S 41/32; F21Y 2113/10; F21S 43/14; F21S 43/31; F21S 41/36; F21S 41/148

(57) ABSTRACT

Optical device (2A, 2B, 2C) for a motor vehicle providing two separate lighting functions, comprising an optical housing (4) open at a front face (12). The optical housing (4) comprises a first light source (18) arranged for illuminating a first surface (32). The optical housing (4) also comprises a second light source (20) arranged for illuminating a second surface (40), the second surface (40) being a concave shape and arranged for reflecting a light beam (34B) emitted by the second light source (20) in the direction of the front face (12) of the optical housing (4). The invention is wherein the first surface (32) is positioned between the front face (12) and the second surface (40) and in that the first surface comprises a channel (42) through which at least a portion of the light beam (34B).

### CROSS-REFERENCE TO RELATED APPLICATIONS

The present application is a National Stage of International Patent Application No. PCT/FR2018/052178, filed on Sep. 6, 2018, which claims priority to and all the benefits of French Patent Application No. 1758265, filed on Sep. 7, 2017, both of which are hereby expressly incorporated herein by reference in their entirety.

### TECHNICAL FIELD

The present invention relates to the technical field of vehicle lighting and signalling, in particular for motor vehicles. It more particularly relates to an optical device for a motor vehicle, integrating two separate lighting functions for a smaller bulk.

### STATE OF THE ART

The regulatory standards impose that each motor vehicle is equipped with optical devices for its signalling and for warning the other road users about its driver's intentions. Turn signal lights of amber colour for indicating a change of direction of the vehicle, side marker lights of red colour and moderate intensity that are located on the rear of the vehicle for signalling the position thereof, brake lights also of red colour but of higher intensity for signalling a braking, etc., may in particular be mentioned.

Generally, these different lights or optical devices are present in a same optical housing. They are arranged so that their light beams illuminate separate areas of a same screen sealing the optical housing. That way, the optical housing must include a screen of sufficient size to allow each light to illuminate a separate surface of the screen so that each light can fulfil its function. The optical housings have hence a certain size at their screen, one drawback of which is to make their integration in a motor vehicle more difficult.

According to another drawback, the different lights are visible through the screen protecting the inside of the optical housing. Now, the lights are generally of various shapes, complex and of different colours. That way, each optical housing locally and pronouncedly modifies the aesthetic aspect of the motor vehicle.

The present invention aims at solving these problems by proposing an optical device providing two separate lighting functions while being of more compact and more discreet visual aspect.

### DESCRIPTION OF THE INVENTION

For that purpose, the invention proposes an optical device for a motor vehicle including an optical housing open at a front face, the optical housing comprising:
a first light source arranged for illuminating a first surface present in the optical housing, the first surface being configured to reflect a light beam emitted by the first light source in the direction of the front face of the optical housing; and
a second light source arranged for illuminating a second surface present in the optical housing, the second surface being concave in shape and configured to reflect a light beam emitted by the second light source in the direction of the front face of the optical housing.

The invention is remarkable in that the first surface is positioned between the front face of the optical housing and the second surface, and the first surface includes a passage through which at least a part of the light beam reflected by the second surface passes.

The invention hence proposes an original optical device comprising an optical housing in which is present a first reflective surface, positioned in front of a second reflective surface. The first reflective surface includes an opening or a passage for the light beam reflected by the second surface to pass through the first surface. The light beams emitted by the first and the second light sources can hence pass, simultaneously or alternatively, through a same opening or surface delimited by the front face of the optical housing. In other words, the invention allows light beams, different or identical in intensity and/or in colour, to pass through a same window delimited by the front face of the optical housing. The present invention hence proposes an optical device adapted to provide two separate lighting functions by means of light beams emitted by the first and the second light sources, while being more compact at its front face with respect to the state of the art. Hence, an optical device according to the invention is more easily integrable to the body of a motor vehicle.

According to another embodiment, the first reflective surface is arranged in such a manner to hide all or almost all the second reflective surface to an observer looking through the opening delimited by the front face of the optical housing. Potentially, a portion of the second surface may be visible by the observer, through the passage arranged in the first surface. However, this embodiment offers the advantage to make visible mainly the first surface in order to offer a more homogeneous and hence more discreet visual aspect of the front face of the optical housing. Hence, an optical device according to the invention is less liable to locally and pronouncedly modify the aesthetic aspect of a motor vehicle.

According to another embodiment, the first surface is configured to scatter the light beam emitted by the first light source. By “scatter”, it is meant herein the reflection by the first reflective surface of a light beam in all the directions. Preferably, the first light source is configured to light the perimeter of the passage at the first surface. This embodiment advantageously allows the passage to be partly, preferably totally, hidden when the first light source is turned on. Indeed, the light beam emitted by the first light source is then scattered by the first reflective surface, so that its reflected light beam covers the passage in part, or preferably totally. Hence, when the first light source is turned on, the perimeter of the passage at the first reflective surface is hardly visible, or even undetectable, by an observer looking at the front face of the optical housing. Preferably, the light beam emitted by the first light source surrounds the passage in order to favour a full hiding of the passage by the light reflected by the first reflective surface.

According to another embodiment, the optical housing is closed or sealed at its front face by a translucent screen, scattering the light coming from the outside of the optical housing. By “translucent”, it is meant herein the fact that the screen is configured to diffusely transmit the light, so that the objects appear blurred through the screen. This embodiment allows the light coming from the outside of the housing to be scattered several times during its travels through the translucent screen and its reflection on the first reflective surface, so that, at the first surface, the perimeter of the passage becomes hardly visible, or even undetectable, by an observer located in front of the optical housing when the light sources are turned off. This embodiment has the advantage to uniformize the appearance of the first reflective surface through the screen, in order to offer a more homogeneous and hence more discreet visual aspect of the front face of the optical housing.

According to another embodiment, the second surface is arranged in such a manner to let more than 60%, preferably more than 70%, of the intensity of the light beam emitted by the second light source pass through the passage of the first surface.

According to another embodiment, the first surface and/or the screen is grained, sandblasted or grooved/striated.

According to another embodiment, the first surface is concave in shape. This embodiment aims at allowing a greater convergence, through the first surface, of the light beam emitted by the first light source.

According to another embodiment, the first light source and the second light source are located on a same side of the optical housing. This embodiment aims at simplifying the arrangement between the first and the second reflective surfaces. Preferably, the first light source is hidden to an observer by an edge of the front face of the optical housing and/or the second light source is hidden to an observer by the first reflective surface.

According to another embodiment, the second reflective surface is configured to reflect the light emitted by the second light source, into a substantially rectilinear light beam. This embodiment is particularly advantageous to include the area illuminated by the second light source into the area illuminated by the first light source. The optical device hence allows obtaining varied visual effects according to whether the first and the second light sources operate simultaneously or alternatively.

According to another embodiment, the first light source and the second light source emit, simultaneously or alternatively, light beams of identical or similar colours.

According to another embodiment, the second light source emits a light beam that is more intense than the first light source. This embodiment is in particular advantageous to indicate to an observer the position of the optical device by means of the first light source and/or to warn him about the intention of the optical device user by means of the second light source. By way of example, the first light source and the second light source emit a light beam of red or substantially red colour.

According to another embodiment, the first light source and the second light source emit, simultaneously or alternatively, light beams of different colours.

According to another embodiment, the first light source includes at least two auxiliary light sources each emitting a light beam of different colour. According to an alternative embodiment, at least one auxiliary light source emits a light beam of white colour and at least another auxiliary light source emits a light beam of orange or amber colour.

Of course, the different characteristics, variants and embodiments mentioned hereinabove may be associated with each other according to various combinations, insofar as they are not mutually incompatible or exclusive.

The invention also relates to a motor vehicle comprising an optical device as described hereinabove.

### DESCRIPTION OF THE FIGURES

The invention will be better understood thanks to the following description that relates to preferred embodiments, given by way of non-limitative examples, and explained with reference to the appended schematic drawings, in which:

FIG. 1 shows a longitudinal cross-section of a first embodiment of an optical device according to the invention comprising a first light source and a second light source, both activated;

FIG. 2 shows a longitudinal cross-section of a second embodiment of an optical device according to the invention in which only the first light source is activated;

FIG. 3 shows a longitudinal cross-section of a third embodiment of an optical device according to the invention in which no light source is activated.

### DESCRIPTION OF DETAILED EMBODIMENTS OF THE INVENTION

As a reminder, the invention aims at proposing an optical device ensuring two separated lighting functions, while having a more compact and more discreet visual aspect.

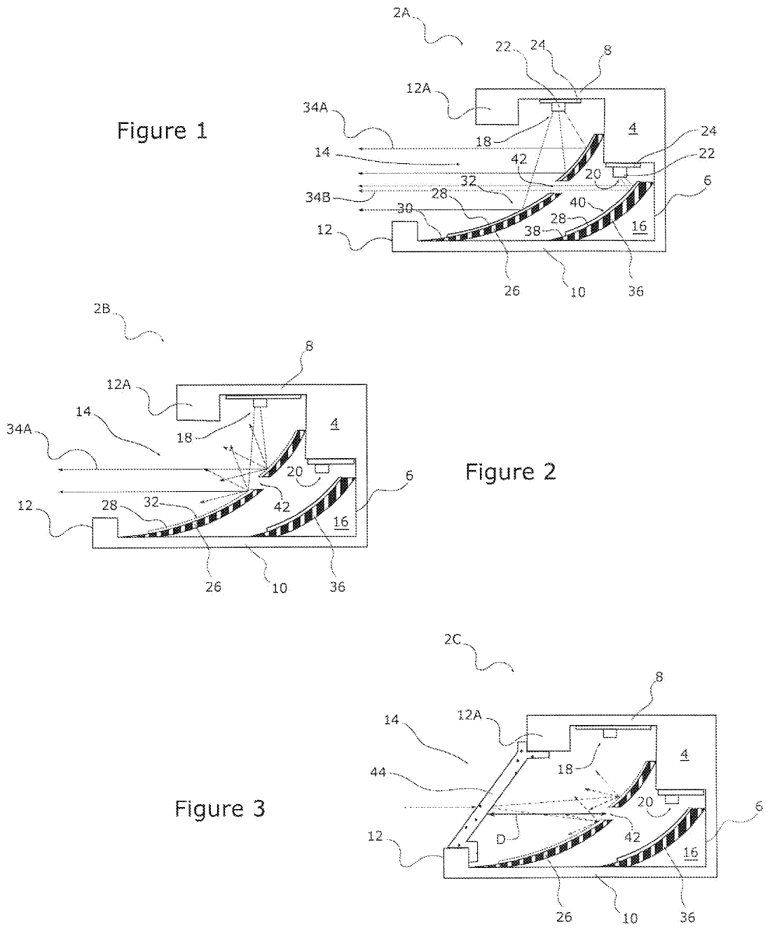

FIG. 1 illustrates a first embodiment of an optical device 2A according to the invention. The optical device 2A comprises an optical housing 4 delimited by a bottom 6, an upper wall 8, a lower wall 10 and two lateral walls not visible in the figures. The optical housing also includes a front face 12 opposite the bottom 6, delimiting an opening 14 in order to allow an observer to view the inside of said housing. The optical housing hence delimits an accommodation 16 in which are present a first light source 18 and a second light source 20, both directed towards the lower wall 10 of the optical housing. Each light source is powered by a control device not shown in the figures, operable for activating simultaneously or alternatively one or several light-emitting diodes 22 placed on plates 24 and forming said light sources. It is to be noted that each light source may comprise one or several auxiliary light sources in the form of light-emitting diodes, not shown in the figures in order to facilitate the understanding of these latter.

More precisely, the first light source 18 is arranged near the upper wall 8 of the optical housing, in such a manner to be hidden behind a portion 12A of the front face of the housing. A first support 26, concave in shape, is positioned opposite the first light source 18 and covered with a metallized layer 28 at an inner face 30, so that the metallized layer 28 forms a first surface 32 reflecting at least a part of a light beam 34A, emitted by the first light source 18, in the direction of the opening 14. In other words, the first surface 32 is configured to let at least a part of the light emitted by the first light source 18 pass through the opening 14.

The second light source 20 is arranged between the first support 26 and the bottom 6 of the optical housing 4. Hence, advantageously, the second light source 20 is hidden by the first support 26 to an observer of the optical housing. The optical housing 4 also comprises a second support 36, concave in shape, positioned opposite the second light source 20, and covered with a metallized layer 28 at an inner face 38, so that the metallized layer 28 forms a second surface 40 reflecting at least a part of a light beam 34B emitted by the second light source 20, in the direction of the first support 26.

The first support 26 as well as its metallized layer 28 are passed through by a passage 42 allowing at least a part of the light beam 34B reflected by the second surface 40 to illuminate at least a portion of the opening 14 of the optical housing 4. Hence, advantageously, two separate light beams can be emitted in the same time or alternatively through the opening 14. That way, the opening 14 of the optical housing 4 may be of smaller size with respect to the optical housings of the state of the art, while allowing the passage through a same opening of two separate light beams providing two distinct light functions.

By way of example, the first light source 18 is configured to emit a light beam of red colour in order to signal the position of the optical device to an observer, and the second light source 20 is configured to emit a light beam of a same colour, but more intense, in order to warn about a braking intention of a user of the optical device 2A.

According to an alternative embodiment, the first light source 18 is configured to emit a light beam of red colour to signal the position of the optical device to an observer, and the second light source 20 is configured to emit a light beam of orange or amber colour in order to indicate a direction change intention of the user of the optical device 2A.

According to another alternative embodiment, the first light source 18 is configured to emit a light beam of red colour to signal the position of the optical device to an observer, and the second light source 20 is configured to emit a light beam of white colour in order to indicate a reversing intention of a user of the optical device 2A.

It is to be noted that the exemplary embodiments described hereinabove may be reproduced by inverting the first and the second light sources.

Preferably, the metallized layers 28 are of same nature so that they have substantially the same visual aspect. Hence, when the light sources are turned off, the passage 42 is little or not at all visible by an observer of the optical device 2A because the passage leads to the second surface 40 whose aspect is very similar or identical to the aspect of the first surface 32. Advantageously, the first surface 32 is hence of substantially homogeneous aspect for an observer of the optical device when the light sources are inactive or turned off. That way, the optical device 2A according to the invention is also of more discreet aspect during the day, with respect to the optical devices of the state of the art.

Now, FIG. 2 illustrates a second embodiment of the invention of an optical device 2B, which is different from the preceding embodiment in that the first surface 32 is scattering and in that the first light source 18 is configured to illuminate in particular the perimeter of the passage 42. The scattering surface is configured to favour a scattering of the light beam 34A emitted by the first light source 18 at the first surface 32. For that purpose, the first surface 32 may have a surface of inhomogeneous, grained, sandblasted and/or grooved texture. Hence, advantageously, the light beam 34A emitted by the first light source 18 is scattered all around the passage 42 so that the passage is partly, preferably totally, covered by the reflected light beam. Hence, when the first light source 18 is turned on, the passage 42 through the first scattering surface 32 is hardly visible, or even undetectable, by an observer looking at the front face of the optical housing.

FIG. 3 illustrates a third embodiment of the invention of an optical device 2C, which is different from the preceding embodiment in that the opening 14 is sealed by a translucent screen 44. This embodiment allows the light coming from the outside of the optical device 4 to be scattered several times during its travels through the translucent screen 44 and its reflection on the first surface 32, so that the passage is hardly visible, or even undetectable, by an observer located in front of the optical housing when the light sources are turned off. This embodiment has the advantage to uniformize the appearance of the first reflective surface through the screen, in order to offer a more homogeneous and hence more discreet visual aspect of the front face of the optical housing 4.

Preferably, the size of the passage 42 is chosen so that the intensity of the light beam 34B reflected by the second surface is sufficient and that the passage is hardly visible through the translucent screen 44. By sufficient intensity of the light beam 34B, it is meant a light beam in accordance with the lighting standards for the motor vehicles.

According to an alternative embodiment, the metallized layer 28 forming the first surface 32 may be of white colour so as to scatter the rays coming from the first light source 18 as well as the light coming from the outside of the optical housing 4. This embodiment is particularly advantageous to optimize the homogeneity of the first surface 32 when the first light source 18 is turned on and to better hide the presence of the passage 42.

According to another alternative embodiment, the ratio between the smallest size of the hole at the first surface 32 and the distance D separating the translucent screen 44 is equal to 5, preferably higher than 5. The value of this ratio aims at allowing a sufficient scattering of the light between the translucent screen 44 and the first surface 32 in order to better hide the presence of the passage 42. Of course, the value of this ratio is liable to evolve as a function of the transmission properties of the translucent screen 44 and/or of the reflection properties of the first surface 32.

1. An optical device (2A, 2B, 2C) for a motor vehicle, including an optical housing (4) open at a front face (12), the optical housing (4) comprising:
a first light source (18) arranged to illuminate a first surface (32) present in the optical housing (4), the first surface (32) being configured to reflect a light beam (34A) emitted by the first light source (18) in the direction of the front face (12) of the optical housing (4); and
a second light source (20) arranged to illuminate a second surface (40) present in the optical housing (4), the second surface (40) being concave in shape and configured to reflect a light beam (34B) emitted by the second light source (20) in the direction of the front face (12) of the optical housing (4);
wherein the first surface (32) is positioned between the front face (12) of the optical housing (4) and the second surface (40) and in that the first surface includes a passage (42) through which at least a part of the light beam (34B) reflected by the second surface (40) passes.

2. The optical device (2A, 2B, 2C) according to claim 1, wherein the first surface (32) is arranged in such a manner to hide all or almost all the second surface (40) to an observer looking through the opening located at the front face (12) of the optical housing (4).

3. The optical device (2B, 2C) according to claim 1, wherein the first surface (32) is configured to scatter the light beam (34A) emitted by the first light source (18).

4. The optical device (2B, 2C) according to claim 3, wherein the first light source (18) is configured to illuminate the perimeter of the passage (42) at the first surface (32).

5. The optical device (2C) according to claim 1, wherein the optical housing (4) is closed at its front face (12) by a translucent screen (44), scattering the light coming from the outside of the optical housing.

6. The optical device (2A, 2B, 2C) according to claim 1, wherein the second surface (40) is arranged in such a manner to let more than 60%, preferably more than 70%, of the intensity of the light beam (34B) emitted by the second light source (20) pass through the passage (42) of the first surface (32).

7. The optical device (2A, 2B, 2C) according to claim 1, wherein the first surface (32) is concave in shape.

8. The optical device (2A, 2B, 2C) according to claim 1, wherein the first light source (18) and the second light source (20) are located on a same side (8) of the optical housing (4).

9. The optical device (2A, 2B, 2C) according to claim 1, wherein the second reflective surface (40) is configured to reflect the light emitted by the second light source (20), according to a substantially rectilinear light beam (34B).

10. The optical device (2A, 2B, 2C) according to claim 1, wherein the first light source (18) and the second light source (20) emit, simultaneously or alternatively, light beams of identical or similar colours.

11. The optical device (2A, 2B, 2C) according to claim 10, wherein the second light source (20) emits a light beam that is more intense than the first light source (18).

12. The optical device (2A, 2B, 2C) according to claim 11, wherein the first light source (18) and the second light source (20) emit, alternatively or simultaneously, light beams of different colours.

13. The optical device (2A, 2B, 2C) according to claim 1, wherein the first light source (18) includes at least two auxiliary light sources each emitting a light beam of different colour.

14. The optical device (2A, 2B, 2C) according to claim 13, wherein at least one auxiliary light source emits a light beam of white colour and at least another auxiliary light source emits a light beam of orange or amber colour.

15. A motor vehicle comprising an optical device (2A, 2B, 2C) according to claim 1.
